(19) United States
(12) Patent Application Publication
(10) Pub. No.: US 2005/0235056 A1
(43) Pub. Date: Oct. 20, 2005

(54) Location system

(76) Inventors: Ken-Li Chen, Tainan County (TW); Wei-Kuo Chiang, Hsinchu City (TW); Jiun-Yao Huang, Nantou City (TW); Shang-Chih Tsai, Taichung-City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/827,215

(22) Filed: Apr. 19, 2004

(51) Int. Cl. G06F 15/173

(52) U.S. Cl. 709/223

(57) ABSTRACT

A location awareness system for a wireless local area network (WLAN). The location awareness system of the present invention allows the infrastructure owner to control the content and method of location related information. The location information translation is performed by the local area server, thus private information is protected inside the WLAN, hidden from to the public presence server. The location awareness system comprises an area agent, a local area server, and a presence server. The area agent obtains location information by providing the area tag to the local area server, and only submits the authorized location information (location awareness information) to the presence server either directly or by the local area server. The present invention further comprises a relay as a cache between the area agent and the local area server.

### BACKGROUND OF THE INVENTION

1. Field of the Invention

The present invention relates to a location system, and more specifically, to a hidden topology location system implemented in a Wireless Local Area Network (WLAN).

2. Description of the Related Art

Popular Internet services provide the current status of contact on the Internet, with some status examples including busy, away, on the phone, and out to lunch, obtained by a location system, an application of the information service.

As shown in FIG. 1, a client 102 of the location system 10 collects information such as Internet Protocol (IP) address, Medium Access Control (MAC) address, and coordinates from the Global Positioning System (GPS), sufficient for determining the current physical location of the client 102. The client 102 then forwards the collected information to a global presence server 101. The presence server receives and records the location information from all the clients of the location awareness system 10, for example, clients 102˜106 in FIG. 1. The location information can be defined as the MAC address of the Access Point (AP), IP address, GPS coordinates, home address, or any other data that describes the location information of the client. The presence server 101 returns the corresponding location information upon receiving a request from a client of the system 10. For example, the client 105 may send a request to the presence server 101 to discover the current location of client 102 through an access point (AP) 107. Once the presence server 101 receives the request, it retrieves and returns the location information of the client 102 to the client 105 through the AP 107. The presence server only distributes the location information of a client to a specific group of people authorized by each individual client.

The existing location system, however, has several shortcomings. The network administrator is unable to manage the content of the location information of the network users to be distributed by the presence server. It is undesirable for the network user to provide private data such as physical address and IP address to the public presence server. Furthermore, current presence platforms are insufficient for providing desire additional capability of translating various types of geographic information into useable context.

### SUMMARY OF THE INVENTION

Accordingly, an object of the present invention is to provide a topology-hiding location system that hides selected elements of location information from a presence server by providing context management.

Another object of the present invention is to allow a network administrator to access location information according to authority of a client.

Yet another object of the present invention is to decentralize location information of network users.

Another object of the present invention is to achieve effective interoperability allowing a current presence server and other platforms to be easily integrated.

To achieve these objects, the present invention provides a location system comprising an area agent, a presence server, a local area server, and an authentication server. The area agent runs a presence application requiring location information of other users. The area agent sends a request comprising an area tag to the local area server to obtain location information, and generates location awareness information based on the obtained location information. The presence server then collects the location awareness information of each area agent of the system for support of the presence application. The local area server can select the method of submission to the presence server. One method is query mode, wherein the area agent submits the location awareness information directly, and in another proxy mode, the local area server submits the location awareness information to the presence server for the area agent.

An embodiment of the location system also comprises a relay for forwarding and managing information exchange between the area agent and the local area server. The relay downloads the location information from the local area server to reduce traffic flow to the local area server, and updates the location information periodically.

Another embodiment of the present invention comprises an authentication server which assigns an authentication code to the area agent, who then forwards the authentication code to the local area server to request the location information. The local area server determines the content of location information derived from the received area tag according to the authentication code, for example, providing only location information with basic data of the access point if the obtained authentication code shows the user is a guest. A possible embodiment of the present invention can construct the relay in the authentication server for information forwarding.

The present invention also provides a method for operating a presence application in an area agent, comprising first acquiring an area tag and an authentication code, obtaining location information from the local area server by sending the area tag and authentication code to the local area server, generating location awareness information according to the obtained location information, and submitting the location awareness information to either the local area server, a relay, or a presence server.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram illustrating conventional location service on the Internet;

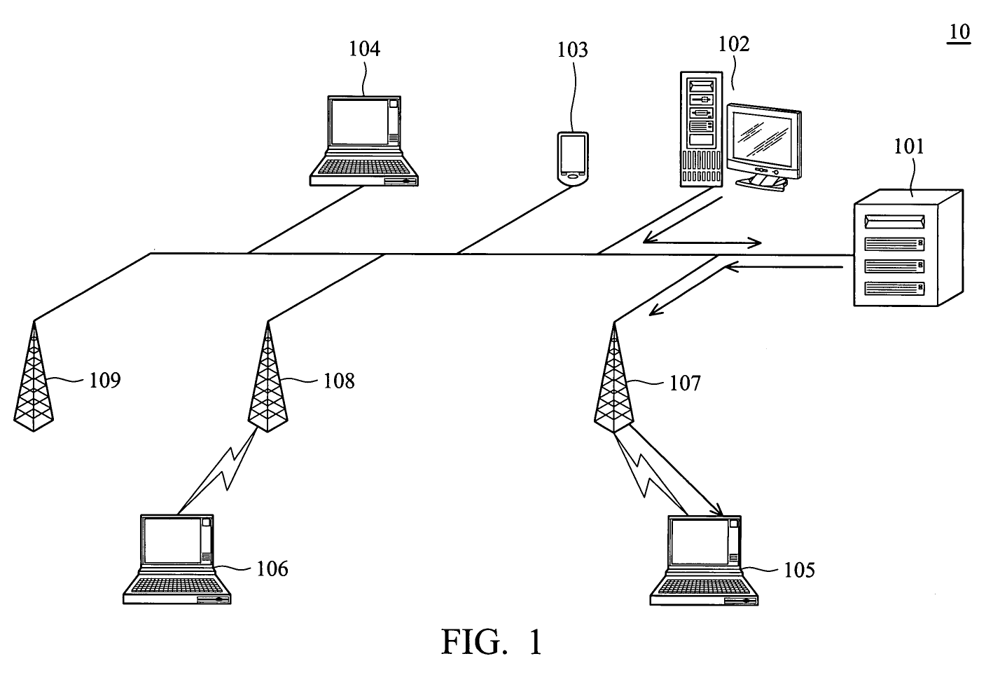

FIG. 2a is a diagram illustrating an example of existing components related to the location system of the present invention;

FIG. 2b is a diagram illustrating an example of the login procedure performed in the location system of the present invention;

FIG. 3 is a diagram illustrating a first embodiment of the location system according to the present invention;

FIG. 4 is a diagram illustrating a second embodiment of the location system according to the present invention;

FIG. 5 is a diagram illustrating a third embodiment of the location system according to the present invention;

FIG. 6 is a table comparing the invention and conventional architecture.

### DETAILED DESCRIPTION OF THE INVENTION

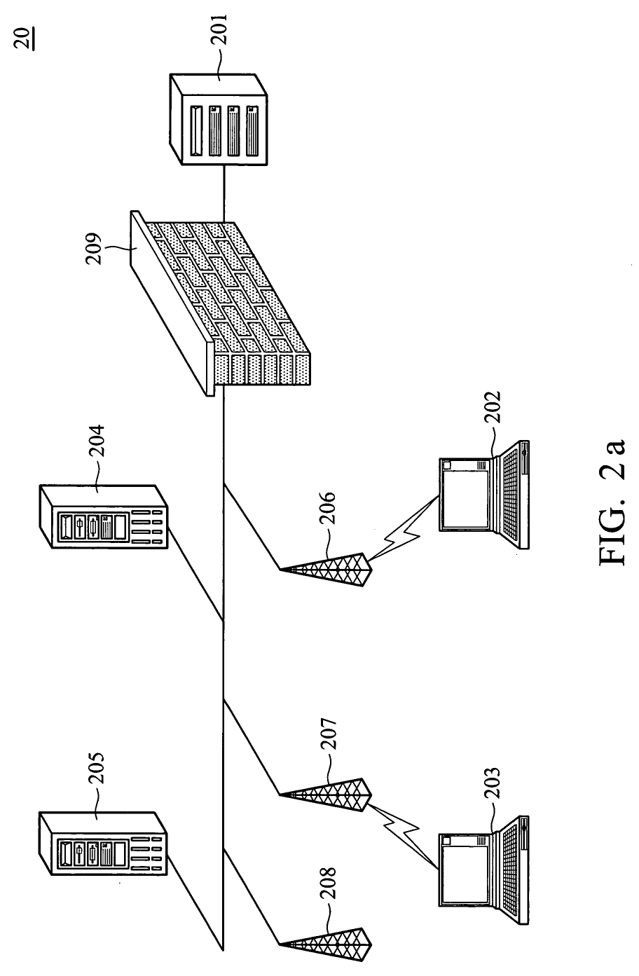

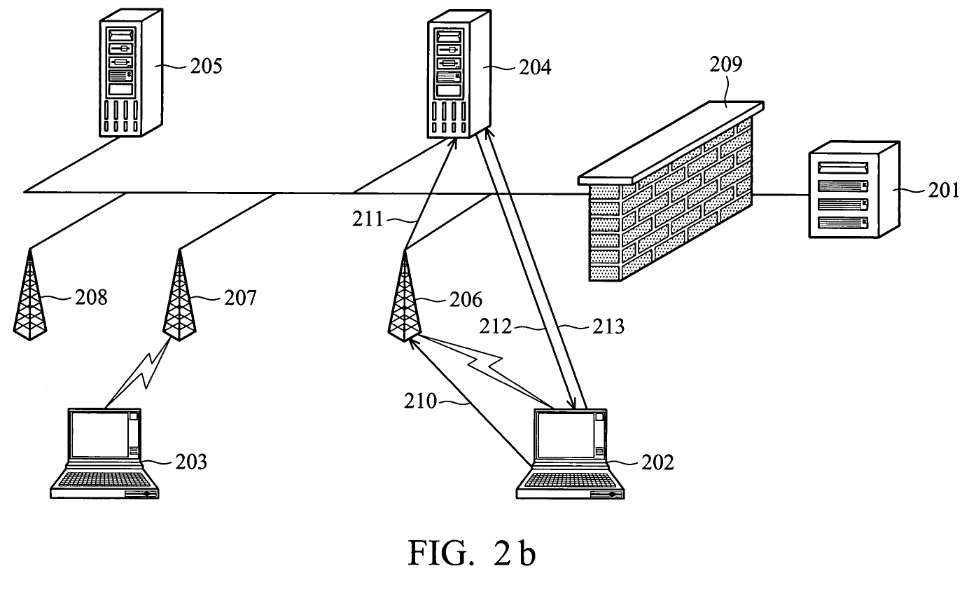

FIG. 2a shows existing components in the location system 20 of the present invention. Laptop computers 202 and 203 are wirelessly connected to Access Points (AP) 206 and 207 respectively. The authentication server 204 performs authentication for each user in the local area network, so that the laptop computers 202 and 203 establish authentication links with the APs 206 and 207. The local area server 205 can be implemented by LDAP, DNS, or proprietary server. The location awareness information of each user in the network is sent to the presence server 201 through a firewall 209. The presence server 201 collects all the location awareness information in order to support location service for users.

FIG. 2b illustrates a Wireless Local Area Network (WLAN) login procedure performed in the location awareness system of FIG. 2a. The laptop computer 202 sends a login request to the AP 206 (step 210). The AP 206 passes the request to the authentication server 204 to request login (step 211) upon receiving the login request. The authentication server 204 challenges the laptop computer 202 with a session key (step 212), and the laptop computer 202 responses with user account (step 213). Subsequently, the laptop computer 202 publishes the location information by sending the information to the presence server 201 using a proper protocol. The login procedure performed by the authentication server 204, however, is optional in the present invention.

The location awareness system of the present invention comprises an area agent, a local area server, and a presence server. The area agent can be a personal computer, a laptop computer, a personal digital assistant (PDA), or any wireless device which operates a presence application. The presence application requires information related to user location provided by the presence server. The area agent obtains an area tag for the corresponding Access Point (AP), such as the Media Access Control (MAC) address, and an area tag from the network layer, such as the DHCP IP address. The area agent then queries its current location by submitting the area tags to the local area server. The local area server translates the area tags and returns the corresponding location information to the area agent. If an authentication server is involved in the location awareness system, the local area server translates the area tags into location information according to a corresponding authentication code assigned by the authentication server. A relay is an optional component in the location awareness system of the present invention, and it prevents the area agent from directly contacting the local area server. The relay reduces workload and traffic flow of the local area server. The relay functions as a cache storing location information for the local area server.

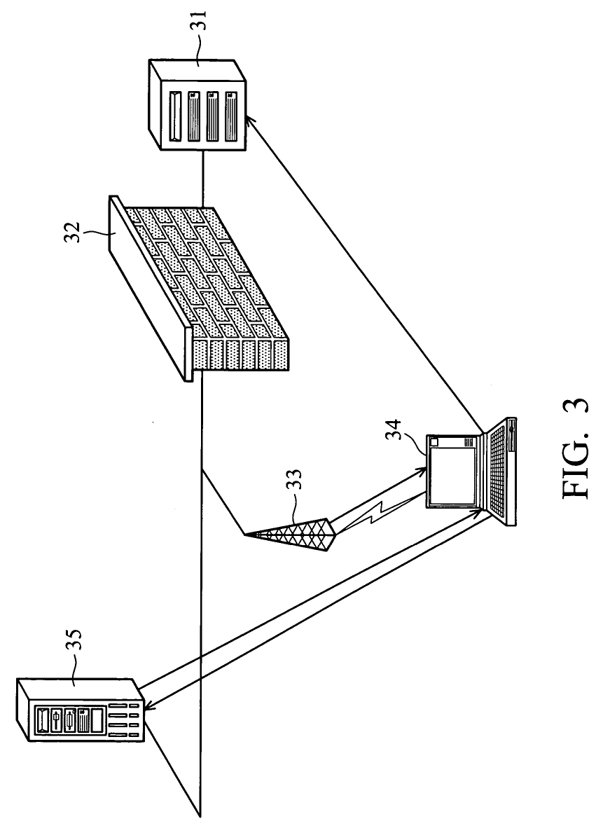

FIG. 3 illustrates a first embodiment of the location awareness system according to the present invention. The first embodiment represents the basic structure of the present invention with no relay present. The laptop computer 34, is the area agent of the system, obtains an area tag from the Access Point (AP) 33. The area tag can be an IP address or MAC address of the AP 33, or any other location related information. The area agent 34 queries the location information corresponding to the area tag by sending the area tag to the local area server 35. The local area server 35 translates the received area tag into location information and returns the location information to the area agent 34. The area agent 34 then determines and generates location awareness information from the location information obtained from the local area server 35. The location awareness information comprises only the specific information that the user of the area agent 34 wishes to publish on the presence server 31. Subsequently, the area agent 34 submits the location awareness information to the presence server 31. A firewall 32 between the wireless local area network (LAN) and the exterior network controls inbound and outbound traffic. The presence server 31 is located in the exterior network, collecting location awareness information from each current user and provides corresponding location awareness information upon request from the users of the presence application.

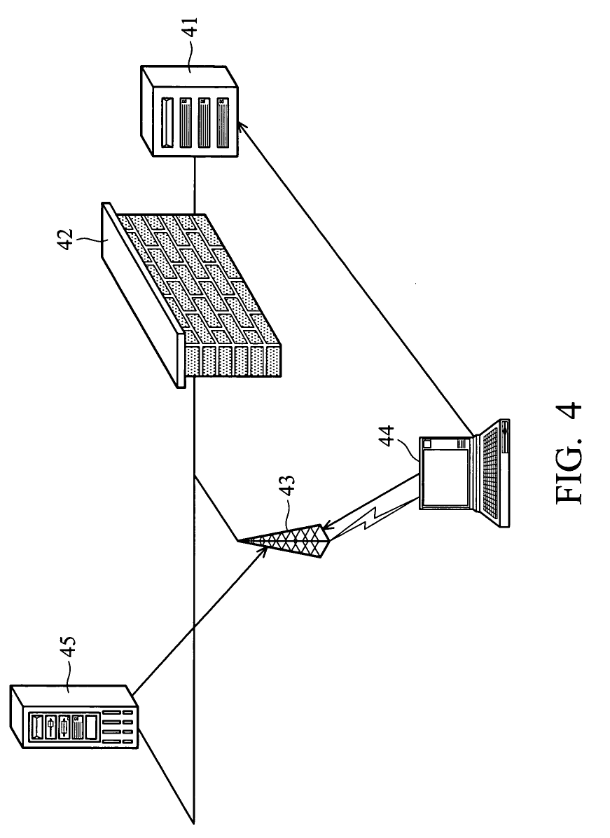

FIG. 4 illustrates a second embodiment of the present invention, wherein all the components shown in FIG. 4 are identical to the components of the first embodiment shown in FIG. 3, with the Access Point 43 functioning as relay. The local area server 45 assigns the location information to the relay, herein the AP 43. The relay 43 stores the location information and provides the location information to the area agent (laptop computer) 44 upon user request. The relay 43 updates the location information provided from the local area server 45 periodically. The area agent 44 determines location awareness information for publication when receiving the location information, and submits the location awareness information to the presence server 41 using a proper protocol.

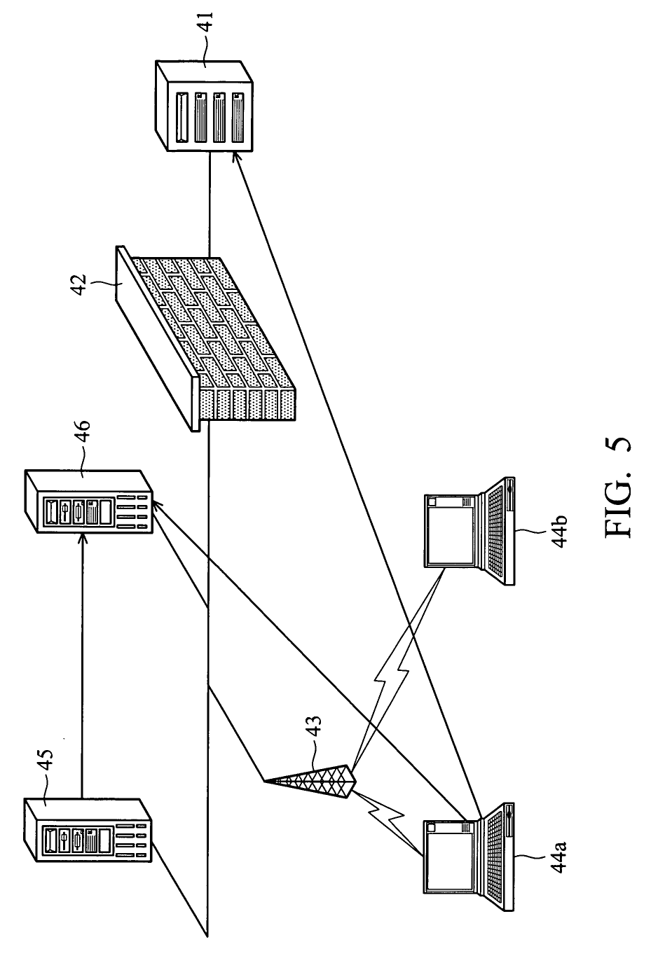

FIG. 5 illustrates a third embodiment of the present invention, wherein an authentication server 46 is deployed in the system. The authentication server 46 is not only responsible for user authentication, but also acts as a relay. The local area server 45 assigns the location information to the authentication server 46. The authentication server 46 stores the location information corresponding to different area tags. When an area agent 44a obtains an area tag from the corresponding AP 43, the area agent 44a sends the area tag to the authentication server 46 to query the location information. The authentication server 46 examines the authentication code of the area agent 44a and provides the location information according to the authentication code. If the area agent 44b also connects to the AP 43, it obtains the same area tag as the area agent 44a. If the area agents 44a and 44b have different authentication codes, the location information obtained from the authentication server 46 may not be the same. The area agents 44a and 44b submit the location awareness information to the presence server 41 through the firewall 42 once the authentication server 46 returns the corresponding location information.

The local area server can operate in query or proxy mode. The difference between the two modes is the method of submitting location awareness information from the area agent to the presence server. The area agent accesses the location information from the local area server and submits the location awareness information to the presence server directly in query mode. The area tag and location awareness information are returned to the local area server for transfer local awareness information to the presence server for the area agent. The first, second, and third embodiments operate in query mode, however, the system may be switched to the proxy mode at any time.

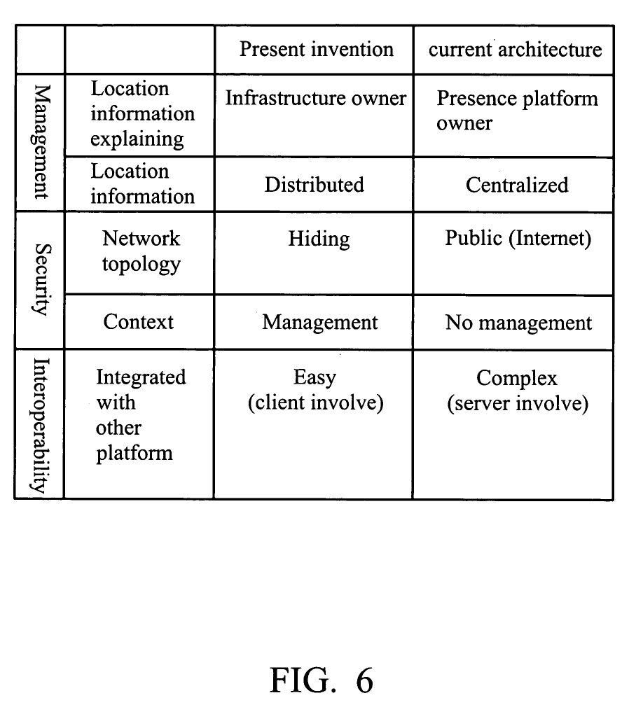

FIG. 6 is a table comparing the location awareness systems of the present invention and conventional architecture. The present invention allows the infrastructure owner to manage translation of the location information, whereas conventional architecture manages the location information translation by the presence platform owner. The distributed management of the present invention is preferable to conventional centralized management. The security level of the present invention is superior to the conventional architecture since the present invention provides a hidden topology system. Private information is hidden inside the LAN, and only authorized information is transmitted to the public presence server. Beside, the context of the location information can be managed by the authentication server. The present invention can be easily integrated with other platforms since only the clients need be integrated. Compared to conventional architecture that required of integrating the servers, the present invention provides superior interoperability.

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A location system, comprising:
an area agent, comprising a presence application;
a presence server, collecting location awareness information supporting the presence application; and
a local area server, returning location information in response to a request from the area agent;
wherein the area agent generates the location awareness information according to the location information obtained from the local area server.

2. The location awareness system according to claim 1, wherein the request sent from the area agent comprises an area tag, according to which, the local area server seeks the location information.

3. The location awareness system according to claim 1, wherein the area agent directly submits the location awareness information to the presence server.

4. The location awareness system according to claim 1, further comprises a relay forwarding and managing information exchange between the area agent and the local area server.

5. The location awareness system according to claim 4, wherein the relay downloads location information from the local area server for periodic update.

6. The location awareness system according to claim 4, wherein the relay retrieves the location awareness information from the area agent for submission to the local area server, which then transfers the location awareness information to the presence server.

7. The location awareness system according to claim 1, further comprises an authentication server assigning an authentication code to the area agent.

8. The location awareness system according to claim 7, wherein the request sent from the area agent comprises the authentication code, and the local area server returns location information according to the authentication code.

9. The location awareness system according to claim 7, wherein the authentication server further comprises a relay for forwarding and managing information exchange between the area agent and the local area server.

10. The location awareness system according to claim 9, wherein the relay collects the location awareness information from the area agent for submission to the local area server, which then publishes the location awareness information to the presence server.

11. A location awareness method for operating a presence application in an area agent, comprising the steps of:
acquiring an area tag;
requesting location information from a local area server by sending the area tag;
obtaining the location information from the local area server;
generating location awareness information accordingly; and
submitting the location awareness information.

12. The location awareness method according to claim 11, wherein the location awareness information is directly submitted to a presence server.

13. The location awareness method according to claim 11, wherein the location awareness information is submitted to a relay for transmission to the local area server.

14. The location awareness method according to claim 11, wherein the location awareness information is submitted to the local area server.

15. The location awareness method according to claim 11, further comprises acquiring an authentication code from a authentication server and sending the authentication code together with the area tag to the local area server to obtain the location information.
